(19) United States
(12) Patent Application Publication
(10) Pub. No.: US 2005/0073258 A1
(43) Pub. Date: Apr. 7, 2005

(54) Planar light source device and image display apparatus having the same

(76) Inventors: Hyeon-Yong Jang, Osan-si (KR); Geun-Young Kim, Seoul (KR)

Correspondence Address: CANTOR COLBURN LLP, 55 Griffin Road South, Bloomfield, CT, 06002, US

(21) Appl. No.: 10/925,579

(22) Filed: Aug. 25, 2004

(30) Foreign Application Priority Data
Oct. 1, 2003 (KR) 2003-68188

(51) Int. Cl. H01J 1/62; H01J 63/04

(52) U.S. Cl. 313/634; 313/493; 313/495

(57) ABSTRACT

A planar light source device includes a light source body, and first and second electrodes. The light source body includes a first substrate, a second substrate facing the first substrate, and partitions disposed between the first and second substrates to define a discharge space. The first electrode includes a first voltage applying portion and a first electrode portion having protrusions extended from the first voltage applying portion and disposed between the partitions. The second electrode is disposed on the light source body, such that the second electrode is spaced apart from the first electrode. The planar light source device generates light having uniform luminance distribution.

### BACKGROUND OF THE INVENTION

1. Field of the Invention

The present invention relates to an image display apparatus, more particularly, to a planar light source device generating light having enhanced uniformity of luminance with reduced power consumption, and an image display apparatus having the planar light source device.

2. Description of the Related Art

Recently developed image display apparatuses include an image display apparatus displaying images by controlling arrangement of liquid crystal molecules. Liquid crystal display devices generally have merits, such as thin thickness, small volume and light weight. Thus, the liquid crystal display devices are widely used for portable computers, communication devices, television sets, etc.

The liquid crystal display devices include a liquid crystal controlling part for controlling liquid crystal and a light providing part for providing the liquid crystal controlling part with light. The liquid crystal controlling part includes pixel electrodes formed on a first substrate, a common electrode formed on a second substrate, and liquid crystal interposed between the pixel electrodes and the common electrode. The number of the pixel electrodes generally determines the resolution of a display device. Each pixel electrode is electrically connected to a thin film transistor, so that a pixel voltage is applied to the pixel electrode. A reference voltage is applied to the common electrode. The pixel electrodes and the common electrode comprise a material that is electrically conductive and optically transparent.

The light providing part provides light to the liquid crystal. The light generated from the light providing part passes through the pixel electrodes, the liquid crystal, and the common electrode in sequence to display images. In such a liquid crystal display device, luminance of the light and its uniformity have an effect on the quality of images displayed thereon. That is, as the light generated from the light providing part has higher luminance and uniformity of the luminance, the display quality of the liquid crystal display apparatus is more improved.

Generally, a cold cathode fluorescent lamp (CCFL) or a light emitting diode (LED) is used for the light providing part. Since both the CCFL and the LED have low uniformity of luminance, the light providing part having the CCFL or the LED includes a light guide plate, a diffusion member, a prism sheet, etc to enhance the uniformity of luminance. Such a configuration causes an increase in the size and weight of a liquid crystal display apparatus having the CCFL or the LED.

To solve the above and other problems, planar light source devices have been developed. A planar light source device has an electrode formed in a coplanar type at both sides or at one side of a lamp. However, since the electrode of the planar light source device has a rod shape, there has been such a problem in the conventional liquid crystal display devices that charges concentrated on the electrode induce arc or crosstalk inside the planar light source device. As a result, luminance of the light provided from the lamp to the liquid crystal display panel is not uniform.

### SUMMARY OF THE INVENTION

The present invention provides a planar light source device having enhanced uniformity of luminance and reduced power consumption.

The present invention also provides an image display apparatus including the planar light source device.

The planar light source device according to the present invention generates light that is uniform regardless of position. Additionally, both variation of luminance and power consumption are reduced.

In one embodiment, the planar light source includes a light source body to include a first substrate, a second substrate facing the first substrate, at least one partition disposed between the first and second substrates, the at least one partition partitioning a space between the first and second substrates to form subspace, and a sealing member sealing the space between the first and second substrates; and electrodes formed on one of the first and second substrates, wherein the electrodes each include at least one protrusion disposed at corresponding one of the subspace. The electrodes each include a voltage applying portion disposed at an end region of the partition, and an electrode portion having protrusions extended from the voltage applying portion. The protrusions are each disposed at corresponding one of the subspaces such that the partition is disposed between adjacent ones of the protrusions without contact with the electrode portion.

The light source body further comprises a first fluorescent layer formed on the first substrate, a reflective layer formed on the second substrate, and a second fluorescent layer formed on the reflective layer. The electrodes comprise silver or conductive tape material. The reflective layer is expanded to cover the partition, and the second fluorescent layer is expanded to cover the reflective layer formed on the partition.

In another embodiment, a planar light source device comprises a light source body to include a first substrate, a second substrate facing the first substrate, at least one partition disposed between the first and second substrates, the at least one partition partitioning a space between the first and second substrates, and a sealing member sealing the space between the first and second substrates; and electrodes formed on both the first and second substrates, wherein the electrodes each include at least one protrusion disposed at corresponding one of the subspace. The electrodes each include a voltage applying portion disposed at an end region of the partition, and an electrode partition having protrusions extended from the voltage applying portion. The electrodes are formed at opposite sides of the first and second substrates and are substantially symmetrical with respect to each other.

In another embodiment, an image display apparatus comprises a planar light source device to include a light source body having a first substrate, a second substrate facing the first substrate, at least one partition disposed between the first and second substrates, the at least one partition partitioning a space between the first and second substrates to form subspaces, and a sealing member sealing the space between the first and second substrates, and electrodes formed on at least one of the first and second substrates, the electrodes each including at least one protrusion disposed at corresponding one of the subspaces; a receiving container to mount the planar light source device; and a liquid crystal panel to convert a light generated from the planar light source device to an image light.

These and other objects, features and advantages of the present invention will become apparent from the following detailed description of illustrative embodiments thereof, which is to be read in connection with the accompanying drawings.

This application relies for priority upon Korean Patent Application No. 2003-68188 filed on Oct. 1, 2003, the contents of which are herein incorporated by reference in its entirety.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a partially cutout perspective view showing a planar light source device according to one embodiment of the present invention;

FIG. 2 is a cross-sectional view of the planar light source device taken along line A-A′ of FIG. 1;

FIG. 3 is a plan view showing a sealing member and a second substrate of FIG. 1;

FIG. 4 is a plan view showing arrangement of partitions of the planar light source device of FIG. 1;

FIG. 5 is a plan view showing another arrangement of partitions of the planar light source device of FIG. 1;

FIG. 6 is a plan view showing a planar light source device according to another embodiment of the present invention;

FIG. 7 is a plan view showing a planar light source device according to another embodiment of the present invention;

FIG. 8 is a plan view showing a planar light source device according to another embodiment of the present invention; and

FIG. 9 is a plan view showing an image display apparatus having a planar light source device according to another embodiment of the present invention.

### DETAILED DESCRIPTION OF THE INVENTION

Hereinafter the embodiments of the present invention will be described in detail with reference to the accompanied drawings.

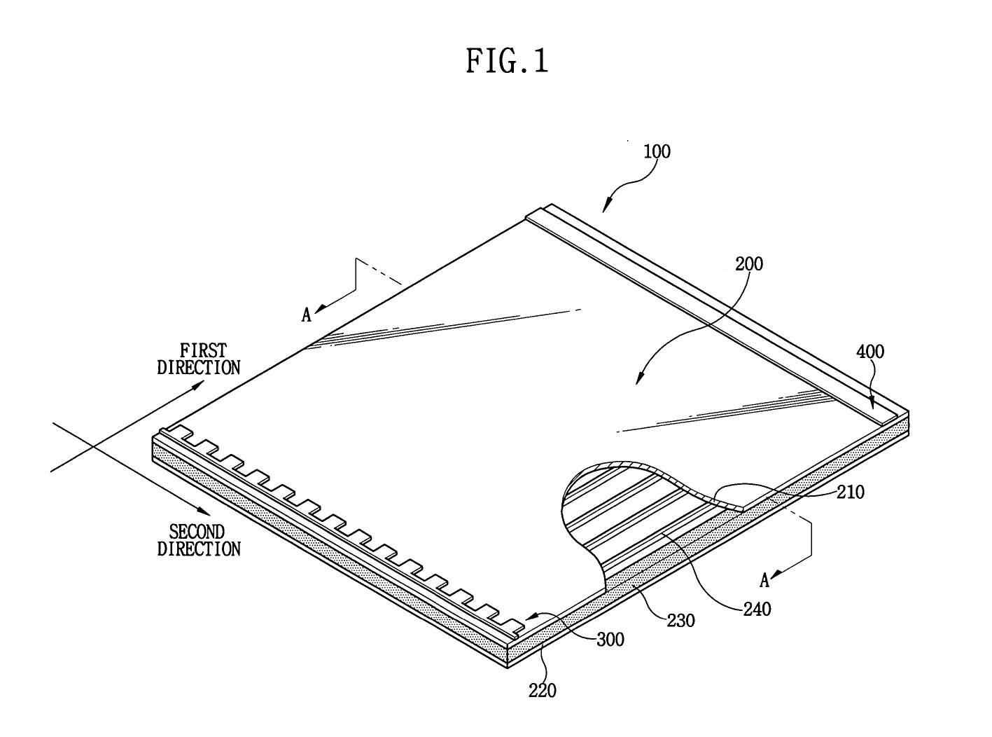

FIG. 1 is a partially cutout perspective view showing a planar light source device according to one embodiment of the present invention. Referring to FIG. 1, the planar light source device 100 includes a light source body 200, a first electrode 300 and a second electrode 400. The light source body 200 includes a first substrate 210, a second substrate 220 and a sealing member 230 and a partition 240.

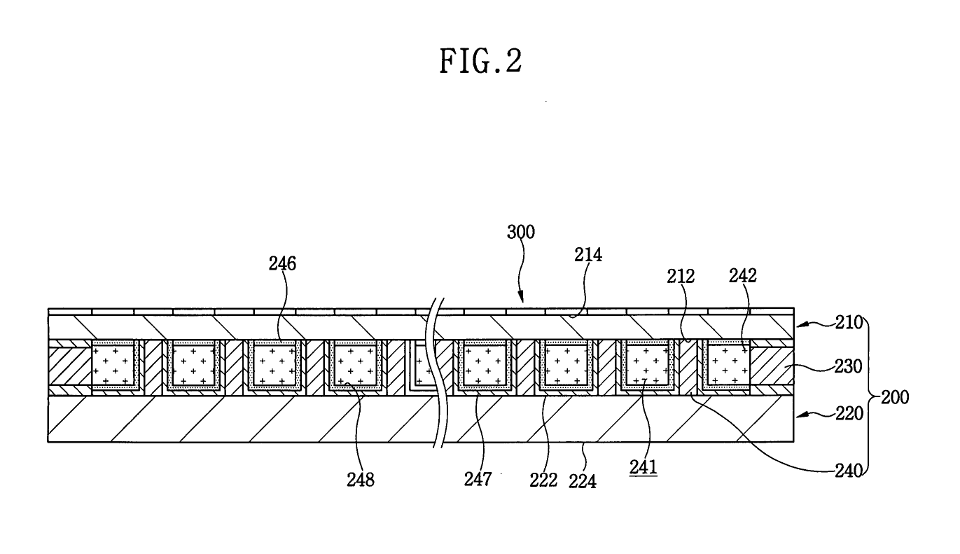

FIG. 2 is a cross-sectional view of the planar light source device 100 taken along line A-A′ of FIG. 1 Referring to FIGS. 1 and 2, the first and second substrates 210 and 220 have a rectangular plate shape, and the first and second substrates 210 and 220 face each other. The first substrate 210 includes a first surface 212 and a second surface 214. The first and second surfaces 212 and 214 face each other. The second substrate 220 includes a third surface 222 and a fourth 224 surface. The third and fourth surfaces 223 and 224 face each other. The first substrate comprises a material that is optically transparent, for example, glass.

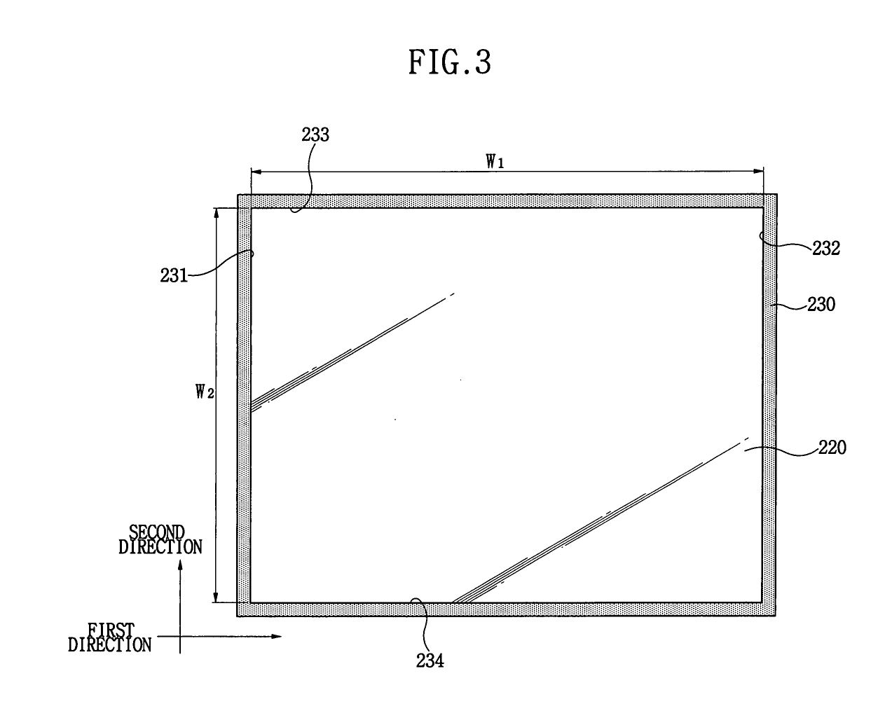

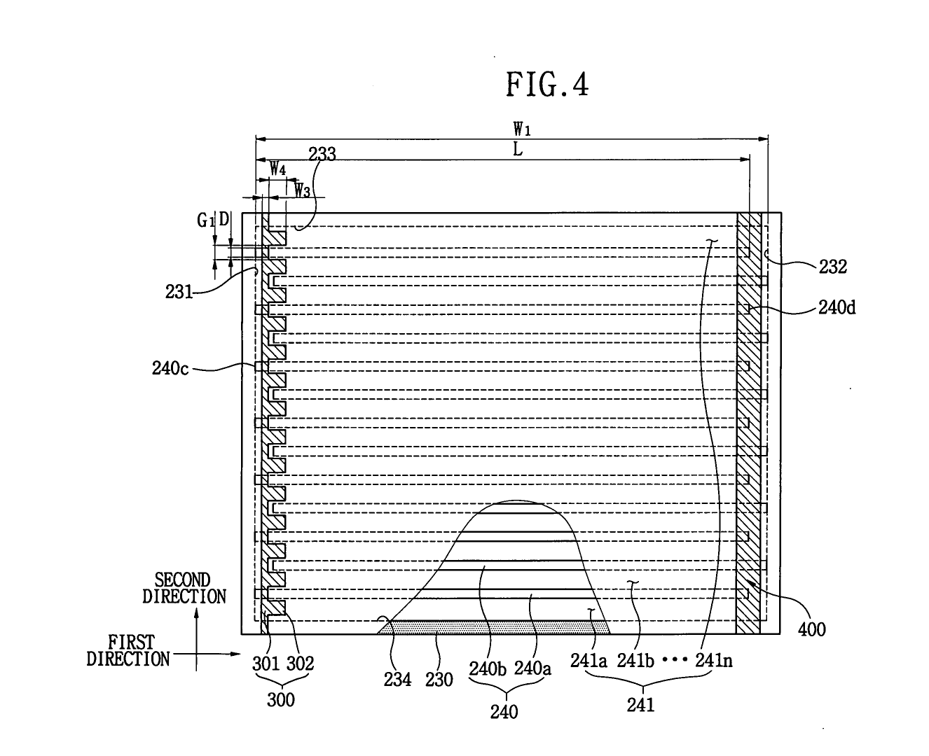

FIG. 3 is a plan view showing the sealing member and the second substrate of FIG. 1 Referring to FIGS. 2 and 3, the sealing member 230 is interposed between the first and second substrates 210 and 220. The sealing member 230 defines the space between the first and second substrates 210 and 220, and the sealing member 230 prevents a discharge gas in the space from being leaked. The sealing member 230 has a rectangular frame shape in accordance with the first and second substrates 210 and 220. The sealing member 230 includes a first internal surface 231, a second internal surface 232, a third internal surface 233, and a fourth internal surface 234. The first and second internal surfaces 231 and 232 face each other. The third and fourth internal surfaces 233 and 234 face each other. The first and second internal surfaces 231 and 232 both have a first width W1, and the third and fourth internal surfaces 233 and 234 both have a second width W2. For example, the first width W1 is substantially longer than the second width W2. FIG. 4 is a plan view showing arrangement of partitions of the planar light source device 100 of FIG. 1.

Referring to FIGS. 1 and 4, the partitions 240 are disposed between the first and second substrates 210 and 220. In this embodiment, the partitions 240 each have a rod shape, and the partitions 240 are extended in a first direction. The partitions 240 divide the space between the first and second substrates 210 and 220 to form a discharge space 241. The partitions 240 prevent the discharge gas from being floated, so that uniform light is emitted at the discharge space. In this embodiment, the partitions 240 are formed on the second substrate 220. However, it is noted that the present invention is not limited to the configuration of this embodiment. For example, the partitions may be formed on the first substrate 210. In another embodiment, the partitions may be protrusions extended from the first or second substrate and integrally formed with the substrate.

The discharge space 241 is partitioned to form a plurality of discharge subspaces 241a, 241b, . . . , 241n. The discharge subspaces 241a, 241b, . . . , 241n are each formed between the adjacent partitions 240. The discharge gas 242 generating invisible light is disposed in the discharge space 241. The amount of the discharge gas 242 has influence on luminance of the light emitted from the planar light source device. Assuming that the discharge subspaces 241a, 241b, . . . , 241n each have a different amount of discharge gas 242, each discharge subspace 241a, 241b, . . . , 241n generates a different quantity of the invisible light to form a different quantity of visible light. In this embodiment, the amount of the discharge gas 242 in the respective discharge subspaces 241a, 241b, . . . , 241n is adjusted to be substantially identical.

Referring to FIGS. 3 and 4, the partitions 240 each have a length L in its first direction. The length L is shorter than the first width W1 between the first and second internal surfaces 231 and 232. The partitions 240 are disposed in a zigzag form, so that the discharge space 241 defined by the partitions 240 forms a serpentine shape. For example, the first ends 240c of the odd numbered partitions 240 make contact with the first internal surface 231 of the sealing member 230, and the second ends 240d of the even numbered partitions 240 make contact with the second internal surface 232. In this way, the discharge subspaces 241a, 241b, . . . , 241n each defined by the respective partitions 240 are connected with each other to form one space formed in a serpentine shape. As a result, the discharge subspaces 241a, 241b, . . . , 241n each have the discharge gas of a substantially same pressure.

Referring again to FIGS. 2 and 4, the first electrode 300 is disposed on the second surface 212 of the first substrate 210. The first electrode 300 includes a first voltage applying portion 301 and a first electrode portion 302. The first electrode 300 is implemented with, for example, a silver (Ag) thin film, a conductive tape or a dipping-plated thin film.

The first voltage applying portion 301 has a band shape. The first voltage applying portion 301 is disposed in a second direction that is substantially perpendicular to the first direction, such that the first voltage applying portion 301 is substantially perpendicular to the partitions 240.

The first electrode portion 302 protrudes from the first voltage applying portion 301, such that the first electrode portion 302 is extended in the first direction. The first electrode portion 302 is disposed between the partitions 240. Thus, the first electrode portion 302 does not overlap with the partitions 240, and the first electrode portion 302 is disposed only in the discharge space 241. In particular, the first electrode portion 302 of the embodiment includes a plurality of protrusions each of which is extended from the first voltage applying portion 301 in the first direction. For example, the first direction means the right-hand direction with respect to the first voltage applying portion 301. The protrusions each have a substantially identical length that determines the width W4 of the first electrode portion 302. The protrusions are each disposed between the adjacent ones of the partitions 240. For example, each protrusion of the first electrode portion 302 has a width larger than a width D of the respective partitions 240.

In this embodiment, the first electrode portion 302 does not overlap with the partitions 240, and such configuration reduces the power consumption. This is because no light is generated at the partitions 240. The density of the discharge gas in the discharge space 241 becomes uniform to prevent variation of luminance.

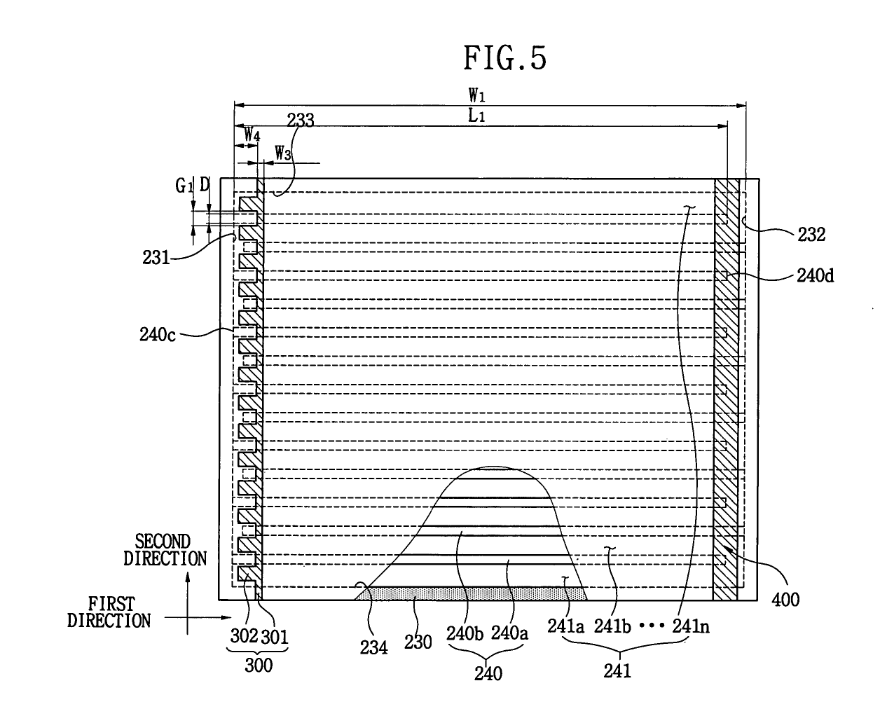

In the embodiment, the first electrode portion 302 is disposed between the first voltage applying portion 301 and the second electrode 400. However, the first voltage applying portion 301 may be interposed between the first electrode portion 302 and the second electrode 400 as shown in FIG. 5.

The number of the protrusions of the first electrode portion 302 is determined in accordance with the number of the discharge subspaces in the partitions 240. The third width W3 of the first voltage applying portion 301 is substantially smaller than 10% of the fourth width W4 of the first electrode portion 302. Additionally, a first gap G1 between the adjacent protrusions of the first electrode portion 302 is larger than the thickness D of each of the partitions 240. The second electrode 400 is disposed on the second surface 212 of the first substrate 210. A silver (Ag) thin film, a conductive tape and a plated thin film may be used as the second electrode 400. The first and second electrodes 300 and 400 are spaced apart with each other. A first driving voltage is applied to the first electrode 300, and a second driving voltage is applied to the second electrode 400. The difference between the first and second driving voltages is large enough to cause discharge of the discharge gas 243, so that ultraviolet light is generated by the discharge gas 242.

Referring again to FIG. 2, the light source body 200 further includes a fluorescent layer to convert the ultraviolet light into visible light. The fluorescent layer includes a first fluorescent layer 246 and a second fluorescent layer 248. The first fluorescent layer 246 is disposed on the first surface 212 of the first substrate 210, such that the first fluorescent layer 246 does not overlap with the partitions 240. The second fluorescent layer 248 is formed on the third surface 222 of the second substrate 220 and a surface of the partitions 240. The first and second fluorescent layers 246 and 248 convert the invisible light into the visible light. For example, the first fluorescent layer 246 is thinner than the second fluorescent layer 248. In detail, a thickness of the first fluorescent layer 246 is about 10 μm, and a thickness of the second fluorescent layer 248 is ranged from about 30 μm to about 50 μm. In another embodiment, the first and second fluorescent lamps 246 and 248 may have a substantially identical thickness.

A reflective layer 247 is interposed between the second fluorescent layer 248 and the third surface 222 of the second substrate 220. The reflective layer 247 may include titanium oxide (TiO₃), aluminum oxide (Al₂O₃), etc. Titanium oxide (TiO₃) or aluminum oxide (Al₂O₃) is in a liquid state.

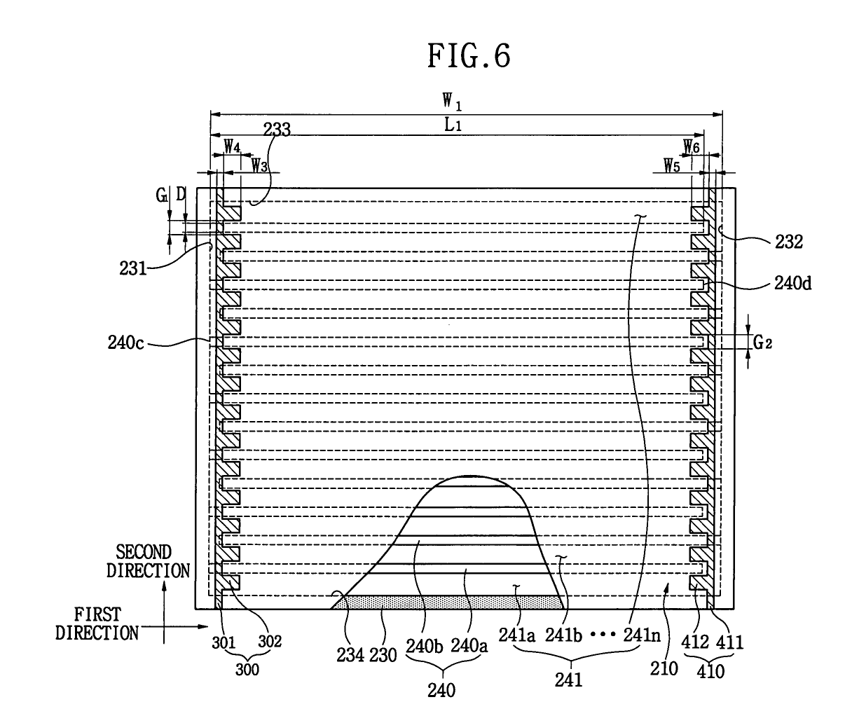

In this embodiment, the first electrode portion 302 of the first electrode 300 is formed to reduce the distance between the first and second electrodes 300 and 400. Thus, uniformity is enhanced, and power consumption is reduced. FIG. 6 is a plan view showing a planar light source device 100 according to another embodiment of the present invention. The planar light source device 100 is the substantially same configuration as that of the embodiment in FIG. 4 except for a second electrode. Thus, the same reference numerals will be used to refer to the same or like parts as those described in the embodiment of FIG. 4 and any further explanation will be omitted.

Referring to FIG. 6, a second electrode 410 is disposed in a second direction. The second electrode 410 includes a second voltage applying portion 411 and a second electrode portion 412.

The second voltage applying portion 411 has a band shape. The second voltage applying portion 411 is disposed in a second direction that is substantially perpendicular to the first direction, such that the second voltage applying portion 411 is substantially perpendicular to the partitions 240.

The second electrode portion 412 protrudes from the second voltage applying portion 411, such that the second electrode portion 412 is extended in the first direction. The second electrode portion 412 is disposed between the partitions 240. Thus, the second electrode portion 412 does not overlap with the partitions 240, and the second electrode portion 412 is disposed only in the discharge space 241. In particular, the second electrode portion 412 of the embodiment includes a plurality of protrusions each of which is extended from the second voltage applying portion 411 in the opposite direction of the first direction. In this embodiment, the opposite direction of the first direction means the left-hand direction with respect to the second voltage applying portion. The protrusions each have a substantially identical length that determines the width W4 of the second electrode portion 412. The protrusions are each disposed between the adjacent ones of the partitions 240. For example, each protrusion of the second electrode portion 412 has a width larger than a width D of the respective partitions 240. The second gap G2 is substantially equal to the first gap G1. In this way, the first electrode 300 is substantially symmetrical to the second electrode 410.

In this embodiment, the second electrode portion 412 does not overlap with the partitions 240, and this configuration reduces the power consumption. This is because no light is generated at the partitions 240. The density of the discharge gas in the discharge space 241 becomes uniform to prevent variation of luminance.

In this embodiment, the second electrode portion 412 is disposed between the second voltage applying portion 411 and the first electrode portion 302 of the first electrode 300.

The number of the protrusions of the first electrode portion 302 is determined in accordance with the number of the discharge subspace in the partitions 240. The fifth width W5 of the second voltage applying portion 411 is substantially smaller than 10% of the sixth width W6 of the second electrode portion 412. According to the embodiment, the second electrode portion 412 of the second electrode 410 is extended toward the discharge space to reduce variation of luminance and power consumption.

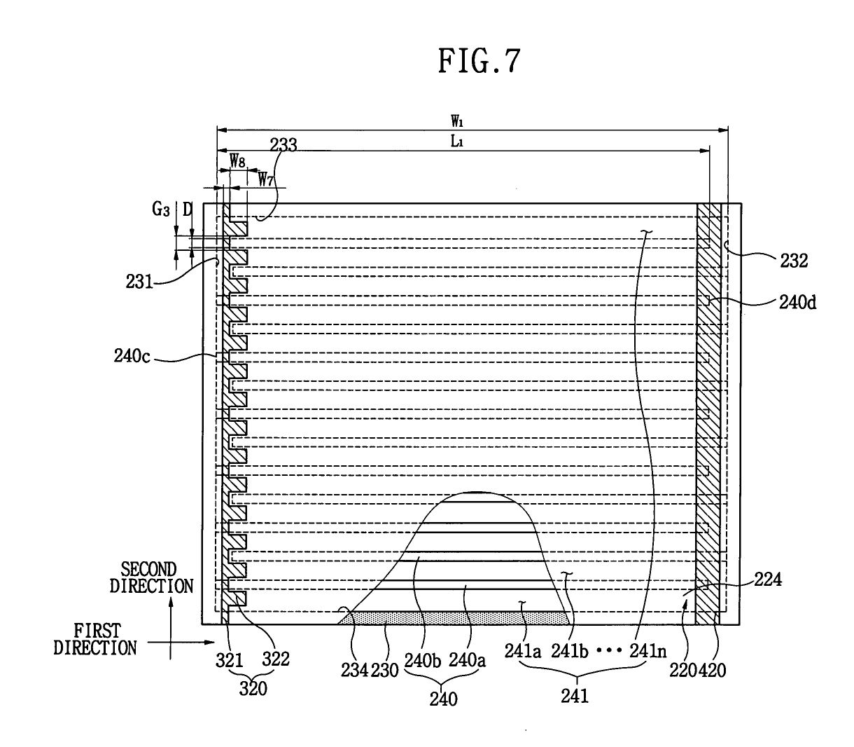

FIG. 7 is a plan view showing a planar light source device according to another embodiment of the present invention. The planar light source device 100 that has the substantially same configuration as that of the embodiment in FIG. 4 except for third and fourth electrodes that are additionally formed. Thus, the same reference numerals will be used to refer to the same or like parts as those described in the embodiment of FIG. 4 and any further explanation will be omitted.

Referring to FIG. 7, the planar light source device further includes a third electrode 320 and a fourth electrode 420. The third electrode 320 is disposed on a fourth surface 224 of a second substrate 220, and the fourth electrode 420 is also disposed on a fourth surface 224, such that the fourth electrode 420 is spaced apart from the third electrode 320.

The third electrode 320 is extended in a second direction. The third electrode 320 includes a third voltage applying portion 321 and a third electrode portion 322. The third electrode portion 322 has a band shape. The third voltage applying portion 321 is substantially perpendicular to the partitions 240. For example, the third voltage applying portion 321 is extended in the second direction that is substantially perpendicular to the first direction.

The third electrode portion 322 protrudes from the third voltage applying portion 321 in the first direction. The third electrode portion 322 is disposed between the partitions 240. Thus, the third electrode portion 322 does not overlap with the partitions 240, and the third electrode portion 322 is disposed only in the discharge space 241. In particular, the third electrode portion 322 of the embodiment includes a plurality of protrusions each of which is extended from the third voltage applying portion 321 in the first direction. The protrusions each have a substantially identical length that determines the width W8 of the third electrode portion 322. The protrusions are each disposed between the adjacent ones of the partitions 240. For example, each protrusion of the third electrode portion 322 has a width larger than a width D of the respective partitions 240.

In this embodiment, the third electrode portion 322 does not overlap with the partitions 240, and this configuration reduces the power consumption. This is because no light is generated at the partition 240. The density of the discharge gas in the discharge space 241 becomes uniform to prevent variation of luminance.

In the embodiment, the third electrode portion 322 is disposed between the third voltage applying portion 321 and the fourth electrode 420.

The first voltage applying portion 301 and the third voltage applying portion 321 are electrically connected to each other, and a first driving voltage is applied to the first and third voltage applying portions 301 and 321. The second and fourth electrodes 400 and 420 are electrically connected to each other, and a second driving voltage is applied to the second and fourth electrodes 400 and 420. The difference between the first and second driving voltages is enough to discharge the discharge gas of the discharge space 241.

The third electrode portion 322 is disposed in discharge space 241, and the seventh width W7 of the third voltage applying portion 321 is substantially smaller than 10% of the eighth width W8 of the third electrode portion 322.

The fourth electrode 420 is disposed on the fourth surface 224 of the second substrate 220. The fourth electrode 420 and the third electrode 320 are spaced apart from each other.

In this embodiment, the additional third and fourth electrodes 322 and 420 are formed on the fourth surface 224 of the second substrate 220 to enhance luminance. Further, uniformity of the luminance is enhanced and power consumption is reduced.

It should be noted that the planar light source device 100 of another embodiment may have the third and fourth electrodes 322 and 420 formed on the second substrate 220 without the first and second electrodes on the first substrate 210.

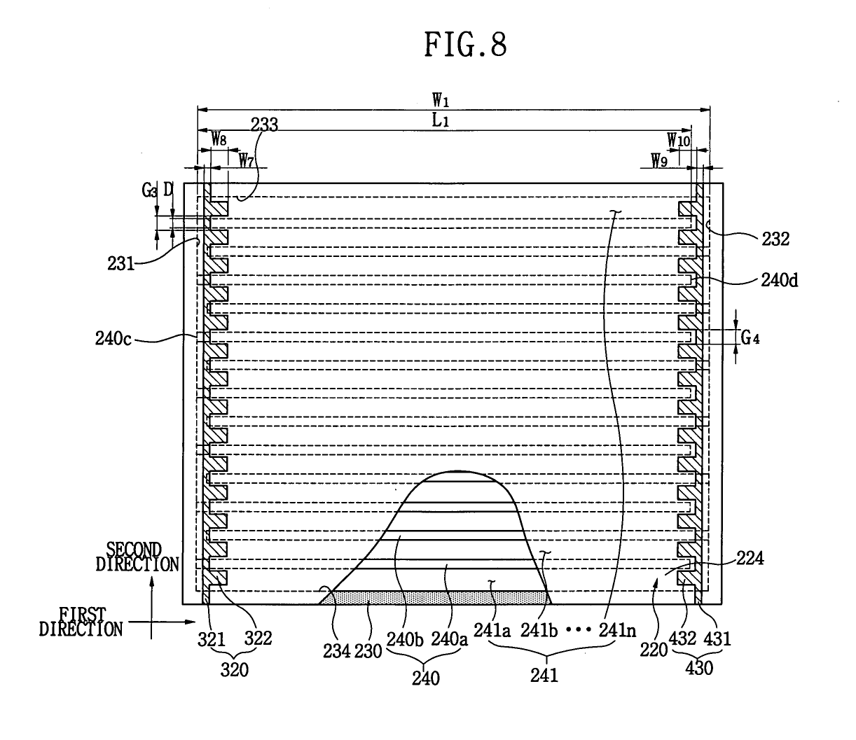

FIG. 8 is a plan view showing a planar light source device 100 according to another embodiment of the present invention. The planar light source device 100 that has the substantially same configuration as that of the embodiment in FIG. 7 except for a fourth electrode. Thus, the same reference numerals will be used to refer to the same or like parts as those described in the embodiment of FIG. 7 and any further explanation will be omitted.

Referring to FIG. 8, a fourth electrode 430 is extended in the second direction. The fourth electrode 430 includes a fourth voltage applying portion 431 and the fourth electrode portion 432.

The fourth voltage applying portion 431 has a band shape. The fourth voltage applying portion 431 is substantially perpendicular to the partitions 240. For example, the fourth voltage applying portion 431 is extended in the second direction that is substantially perpendicular to the first direction.

The fourth electrode portion 432 is extended from the fourth voltage applying portion 431 in the first direction. The fourth electrode portion 432 is disposed between the partitions 240. Thus, the fourth electrode portion 432 does not overlap with the partitions 240, and the fourth electrode portion 432 is disposed only on the discharge space 241. In particular, the fourth electrode portion 432 of the embodiment includes a plurality of protrusions each of which is extended from the fourth voltage applying portion 431 in the first direction. The protrusions each have a substantially identical length that determines the width W10 of the fourth electrode portion 432. The protrusions are each disposed between the adjacent ones of the partitions 240. For example, each protrusion of the fourth electrode portion 432 has a width lager than a width D of the respective partitions 240. The fourth gap G4 is substantially equal to the third gap G3. In this way, the fourth electrode 430 is substantially symmetrical to the third electrode 320.

In this embodiment, the fourth electrode 432 does not overlap with the partitions 240, and this configuration reduces the power consumption. This is because no light is generated at the partitions 240. The density of the discharge gas in the discharge space 241 becomes uniform to prevent variation of luminance.

In the embodiment, the fourth electrode portion 432 is disposed between the fourth voltage applying portion 431 and the third electrode portion 322 of the third electrode 320.

The first voltage applying portion 301 and the third voltage applying portion 321 are electrically connected to each other, so that the first driving voltage is applied to both of the first and third voltage applying portions 301 and 321. The second electrode 420 and the fourth voltage applying portion 430 are electrically connected to each other, so that the second driving voltage is applied to both the second electrode 420 and the fourth voltage applying portion 430.

The seventh width W7 of the fourth voltage applying portion 431 is substantially smaller than 10% of the eighth width W8 of the fourth electrode portion 432.

According to the embodiment, each of protrusions of the fourth electrode portion 432 of the fourth electrode 430 is disposed between the adjacent ones of the discharge subspaces to reduce luminance variation and power consumption.

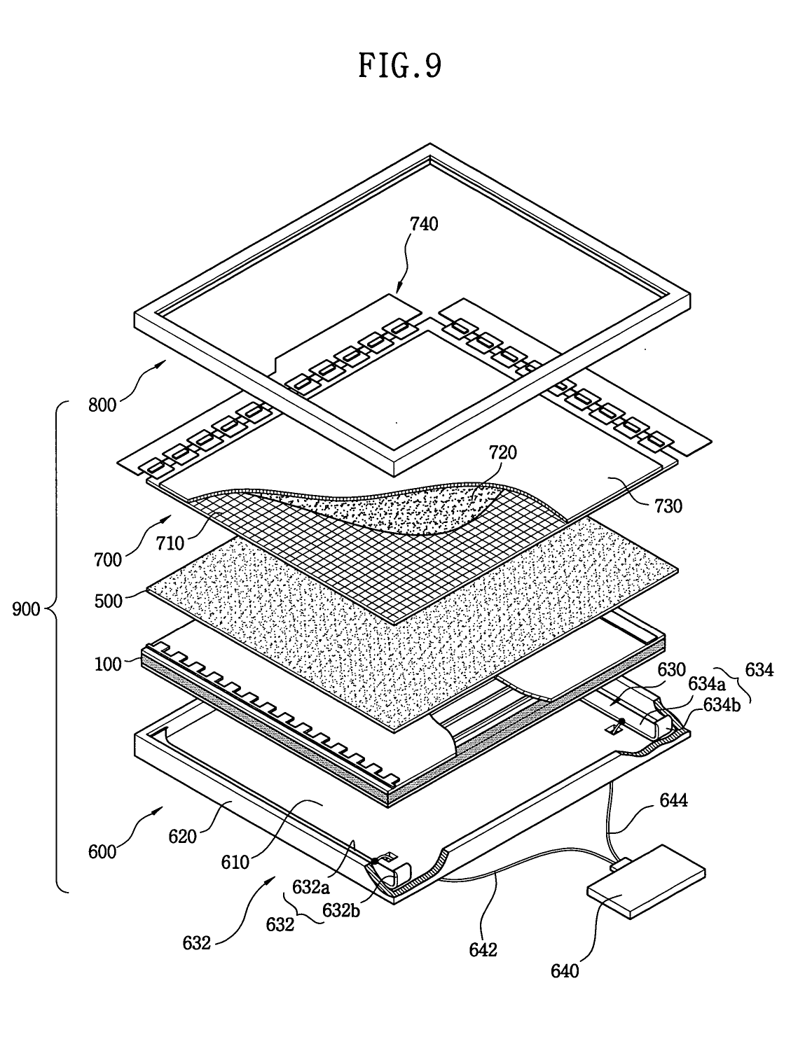

FIG. 9 is a plan view showing an image display apparatus 900 having a planar light source device 100 according to another embodiment of the present invention. The planar light source device 100 is the substantially same configuration as that of the embodiments in FIGS. 4 to 8. Thus, the same reference numerals will be used to refer to the planar light source device 100 in the embodiments of FIGS. 4 to 8, and any further explanation of the planar light source device 100 will be omitted.

Referring to FIG. 9, the image display apparatus 900 includes a receiving container 600, a planar light source device 100, a diffusing plate 500, a flat panel 700 and a chassis 800.

The receiving container 600 includes a bottom plate 610, a plurality of sidewalls 620, a discharge voltage applying module 630 and an inverter 640. The sidewalls 620 protrudes from an edge of the bottom plate 610 to form a receiving space, so that the receiving container 600 settles the planar light source device 100 and the flat panel 700.

The bottom plate 610 has enough area for receiving the planar light source device 100, and the bottom plate 610 has a substantially identical shape with the planar light source device 100. For example, the bottom plate 610 has a rectangular shape. The sidewalls 620 are extended from an edge portion of the bottom plate 610.

The discharge voltage applying module 630 applies the first and second driving voltages to the first and second electrodes 300 and 400, respectively. The discharge voltage applying module 630 includes a first driving voltage applying module 632 and a second driving voltage applying module 634. The first driving voltage applying module 632 includes a first conductive body 632a and a first conductive clip 632b. The second driving voltage applying module 634 includes a second conductive body 634a and a second conductive clip 634b. The first and second electrodes 300 and 400 of the planar light source device 100 are combined with the first and second conductive clips 632b and 634b, respectively.

The inverter 640 applies the discharge voltage to the first and second driving voltage applying modules 632 and 634. The inverter 640 and the first driving voltage applying module 632 are electrically connected to each other via the first conducting wire 642, and the inverter 640 and the second driving voltage applying module 634 are electrically connected to each other via the second conducting wire 644.

The planar light source device 100 includes a light source body 200, and the first and second electrodes 300 and 400. The light source body 200 includes a first substrate 210, a second substrate 220, and partitions 240. The partitions 240 are disposed between the first and second substrates 210 and 220. The first electrode 300 includes a first voltage applying portion 301 and a first electrode portion 302. The first voltage applying portion 301 is disposed, such that the first voltage applying portion 301 is substantially perpendicular to the partitions 240. The first electrode portion 312 is extended in accordance with a discharge space defined by the partitions 240. The second electrode 400 is formed on the light source body 200, such that the second electrode 400 is spaced apart from the first electrode 300.

The flat panel 700 converts light generated from the planar light source device 100 into image light. The flat panel 700 includes a thin film transistor substrate 710, a liquid crystal layer 720, a color filter substrate 730 and a driving module 740.

The thin film transistor substrate 710 includes pixel electrodes, a thin film transistor, a gate line and a data line. The pixel electrodes are arranged in a matrix shape. The thin film transistor applies a driving voltage to the pixel electrodes. The color filter substrate 730 includes a color filter and a common electrode. The color filter faces the pixel electrode. The common electrode is formed on the color filter. The liquid crystal layer 720 is interposed between the thin film transistor substrate 710 and the color filter substrate 730.

The chassis 800 surrounds an edge portion of the color filter substrate 730, and the chassis 800 is combined with the receiving container 600. The chassis 800 protects the flat panel 700. The diffusing plate 500 diffuses a light generated from the planar light source device 100. Optical sheets may be disposed on the diffusing plate 500. Further, a mold frame may be provided to hold the diffusing plate 500, the optical sheets and the flat panel 700. The mold frame may be disposed to maintain a certain distance between the diffusing plate 500 and the planar light source device 100.

The planar light source device 100 according to the present invention generates the light that is uniform regardless of position. Additionally, both variation of luminance and power consumption are reduced.

Having described the exemplary embodiments of the present invention and its advantages, it is noted that various changes, substitutions and alterations can be made herein without departing from the spirit and scope of the invention as defined by appended claims.

1. A planar light source device comprising:
a light source body including a first substrate, a second substrate facing the first substrate, at least one partition disposed between the first and second substrates, the at least one partition partitioning a space between the first and second substrates to form subspaces, and a sealing member sealing the space between the first and second substrates; and
electrodes formed on one of the first and second substrates,
wherein the electrodes each include at least one protrusion disposed at corresponding one of the subspaces.

2. The planar light source device of claim 1, wherein the electrodes each include a voltage applying portion disposed at an end region of the partition, and an electrode portion having protrusions extended from the voltage applying portion.

3. The planar light source device of claim 2, wherein the protrusions are each disposed at corresponding one of the subspaces such that the partition is disposed between adjacent ones of the protrusions without contact with the electrode portion.

4. The planar light source device of claim 2, wherein the at least one partition includes a plurality of partitions, and a width of each protrusion of the electrode portion is smaller than a distance between adjacent ones of the partitions.

5. The planar light source device of claim 4, wherein the width of each protrusion is larger than a width of the respective partitions.

6. The planar light source device of claim 2, wherein the protrusions of the electrode portion are extended in the left direction with respect to the voltage applying portion.

7. The planar light source device of claim 2, wherein the protrusions of the electrode portion are extended in the right direction with respect to the voltage applying portion.

8. The planar light source device of claim 2, wherein the electrodes are each formed at each of opposite sides in one of the first and second substrates, the electrodes formed at the opposite sides, respectively, being substantially symmetrical.

9. The planar light source device of claim 1, wherein the light source body further comprising:
a first fluorescent layer formed on the first substrate;
a reflective layer formed on the second substrate; and
a second fluorescent layer formed on the reflective layer.

10. The planar light source device of claim 9, wherein the reflective layer is expanded to cover the partition, and the second fluorescent layer is expanded to cover the reflective layer formed on the partition.

11. The planar light source device of claim 2, wherein the electrodes comprise silver or conductive tape material.

12. The planar light source device of claim 2, wherein a width of the voltage applying portion is smaller than 10% of a width of the electrode portion.

13. A planar light source device comprising:
a light source body including a first substrate, a second substrate facing the first substrate, at least one partition disposed between the first and second substrates, the at least one partition partitioning a space between the first and second substrates to form subspaces, and a sealing member sealing the space between the first and second substrates; and
electrodes formed on both the first and second substrates,
wherein the electrodes each include at least one protrusion disposed at corresponding one of the subspaces.

14. The planar light source device of claim 13, wherein the electrodes each include a voltage applying portion disposed at an end region of the partition, and an electrode partition having protrusions extended from the voltage applying portion.

15. The planar light source device of claim 14, the electrodes are formed at opposite sides of the first and second substrates, the electrodes being substantially symmetrical with respect to each other.

16. An image display apparatus comprising:
a planar light source device including a light source body having a first substrate, a second substrate facing the first substrate, at least one partition disposed between the first and second substrates, the at least one partition partitioning a space between the first and second substrates to form subspaces, and a sealing member sealing the space between the first and second substrates, and electrodes formed on at least one of the first and second substrates, the electrodes each including at least one protrusion disposed at corresponding one of the subspaces;
a receiving container to mount the planar light source device; and
a liquid crystal panel to convert light generated from the planar light source device to image light.

17. The image display apparatus of claim 16, wherein the electrodes each include a voltage applying portion disposed at an end region of the partition, and an electrode portion having protrusions extended from the voltage applying portion.

18. The image display apparatus of claim 17, wherein the protrusions are each disposed at corresponding one of the subspaces such that the partition is disposed between adjacent ones of the protrusions without contact with the electrode portion.

19. The image display apparatus of claim 17, wherein the electrodes are formed at opposite sides of the at least one of the first and second substrates, the electrodes being substantially symmetrical with respect to each other.
